(19) United States
(12) Patent Application Publication
(10) Pub. No.: US 2016/0116391 A1
(43) Pub. Date: Apr. 28, 2016

(54) METHOD FOR ONLINE MEASUREMENT OF LOCAL PERMEABILITY IN RESIN TRANSFER MOLDING

(71) Applicant: National Tsing Hua University, Hsinchu (TW)

(72) Inventors: Yuan Yao, Hsinchu (TW); Pai-Chien Wei, Hsinchu (TW); Yu-Sung Chang, Hsinchu (TW)

(21) Appl. No.: 14/591,368

(22) Filed: Jan. 7, 2015

(30) Foreign Application Priority Data
Oct. 27, 2014 (TW) 103136978

(51) Int. Cl. G01N 15/08

(52) U.S. Cl. CPC G01N 15/08; G01N 15/088

(57) ABSTRACT

A method for online measurement of local permeability in resin transfer molding adopts a detection module, which includes a pressure transducer unit, at least one image capture device and a processing unit electrically connected with the pressure transducer unit and the image capture device, to measure the local permeability of the flowing resin on line.

### FIELD OF THE INVENTION

The present invention relates to a permeability measurement method, particularly to a method for online measurement of local permeability in resin transfer molding.

### BACKGROUND OF THE INVENTION

Fiber reinforced polymer (abbreviated as FRP) is a composite material featuring high strength and lightweightness. FRP has been widely used in various fields, such as automobile industry, aerospace industry, military industry, construction industry, and staple merchandise. Resin transfer molding (abbreviated as RTM) is a method to fabricate FRP, injecting a thermosetting resin into an enclosed mold and impregnating a pre-woven fiber object (a preform) with the thermosetting resin. In RTM, process parameters greatly influence the quality of products, especially the resin filling parameters. Normally, permeability is used as a parameter to evaluate the behavior of resin filling.

So far, there have been many researches in measuring the resin permeability to pre-woven fiber objects. For example, T. J. Wang, C. H. Wu, and L. J. Lee proposed a paper “In-plane permeability measurement and analysis in liquid composite molding” in Polymer Composites (vol. 15, pp. 278-288, 1994), which visualized the fabrication process to observe the flow direction in different fiber structures and developed a method to determine the main flow directions and the absolute values of in-plane permeabilities for the resin flowing unidirectionally or radiately. Y. S. Song and J. R. Youn proposed a paper “Flow advancement through multi-layered preform with sandwich structure” Composites Part A: Applied Science and Manufacturing, vol. 38, pp. 1082-1088, 2007), which proposed an analysis model considering the resin transverse flow between neighboring fibers to predict the time-dependent advancement of the flow front, and which compared the experimental result and the simulation result to verify the analysis model and then developed an effective permeability to evaluate the influence of the resin transverse flow between neighboring layers on the overall flow behavior. K. K. Han, C. W. Lee, and B. P. Rice proposed a paper “Measurements of the permeability of fiber preforms and applications” in Composites Science and Technology (vol. 60, pp. 2435-2441, 2000), which measured the pressure of the radiately-flowing resin having impregnating the preform and reaching a stable state to predict the in-plane permeability of an anisotropic preform.

The abovementioned prior arts all supposed that the permeability or filling pressure of the preform is a constant. In fact, the permeability is not a constant but varies in different regions. Therefore, the abovementioned prior arts have poor accuracy. Besides, as the abovementioned prior arts normally undertake offline data processing, they are unlikely to control or even optimize the fabrication process in online.

### SUMMARY OF THE INVENTION

The primary objective of the present invention is to solve the problem that the conventional methods for measuring the permeability in resin transfer molding can only obtain the average value and have poor accuracy and the problem that the conventional methods for measuring permeability in resin transfer molding can only work off line and are hard to realize online monitoring and control.

In order to achieve the abovementioned objective, the present invention proposes a method for online measurement of local permeability in resin transfer molding, which is applied to measuring permeability in a resin transfer molding (RTM) apparatus. The RTM apparatus comprises a resin supply unit and a molding unit connected with the resin supply unit. The molding unit includes a mold cavity accommodating a pre-woven fiber object (a preform) and a plane inside the mold cavity. The method of the present invention comprises

Step 1: defining on the plane a plurality of detection positions y_{m,n} whose number amounts to m×n;

Step 2: providing a detection module including a pressure transducer unit arranged in the detection positions y_{m,n}, at least one image capture device arranged on one side of the plane, and a processing unit electrically connected with the pressure transducer unit and the image capture device, wherein the pressure transducer unit includes m×n pieces of pressure transducers;

Step 3: filling the resin into the mold cavity and letting the resin flow on the plane along a direction;

Step 4: using the image capture device to obtain the position x_{i,j} of the flow front of the resin in the plane at a time point tᵢ, and defining on the plane a plurality of measurement positions x_{i,j}, whose number amounts to i×j, wherein the time point tᵢ and the time point tᵢ₋₁ are separated by a sampling interval, and wherein the measurement position x_{i,j} is a position corresponding to the position of the flow front of the resin at the time point tᵢ, and wherein i denotes the ith sampling time point, and j is an integer related to n;

Step 5: setting i and j to be preset values r and a respectively, wherein r is an integer greater than 1 and a is an integer greater than or equal to 1, and using the image capture device to obtain the measurement positions x_{r,a} and x_{r-1,a} respectively at the time points tᵣ and the time point tᵣ₋₁, and using the pressure transducer nearest to the measurement position x_{r,a} and the flow front of the resin has reached to obtain the pressure P_{s,a} of the flow front at the detection position y_{s,a}; and

Step 6: using the processing unit to obtain the permeability K_{r,a} of a measurement position x_{r,a} with Equation (1):

$${K}_{r , a} = \frac{μ θ}{{P}_{s , a} Δ T} ( {x}_{r , a} - {x}_{r - 1 , a} ) ( {x}_{r , a} - {y}_{s , a} ) \qquad ( 1 )$$

wherein Ø is the porosity of the preform, μ the viscosity of the resin, ΔT=tᵣ−tᵣ₋₁, whereby is acquired the permeability at a specified position on the plane.

The present invention further proposes another method for online measurement of local permeability in resin transfer molding, which is applied to measuring permeability in a resin transfer molding (RTM) apparatus. The RTM apparatus comprises a resin supply unit and a molding unit connected with the resin supply unit. The molding unit includes a mold cavity accommodating a pre-woven fiber object (a preform) and a plane arranged inside the mold cavity and allowing the resin to flow thereon. The method of the present invention comprises

Step 1: defining on the plane a plurality of detection positions y_{m,n}, whose number amounts to m×n;

Step 2: providing a detection module including a pressure transducer unit arranged in the detection positions y_{m,n}, at least one image capture device arranged on one side of the plane, and a processing unit electrically connected with the pressure transducer unit and the image capture device, wherein the pressure transducer unit includes m×n pieces of pressure transducers;

Step 3: filling the resin into the mold cavity and letting the resin flow on the plane along a direction;

Step 4: using the image capture device to obtain the position x_{i,j} of the flow front of the resin in the plane at a time point tᵢ, and defining on the plane a plurality of measurement positions x_{i,j}, whose number amounts to i×j, wherein the time point tᵢ and the time point tᵢ₋₁ are separated by a sampling interval, and wherein the measurement position x_{i,j} is a position corresponding to the position of the flow front of the resin at the time point tᵢ, and wherein i denotes the ith sampling time point, and j is an integer related to n;

Step 5: setting i and j to be preset values r and a respectively, wherein r is an integer greater than or equal to 1 and a is an integer greater than or equal to 1, and using the image capture device to obtain the measurement positions x_{r-b,a}, x_{r-b+1,a} . . . x_{r,a} respectively at the time points t_{r-b}, t_{r-b+1} . . . tᵣ, wherein b is an integer greater than zero and r−b>0, and wherein each two neighboring time points of t_{r-b}, t_{r-b+1} . . . tᵣ are separated by the sampling interval;

Step 6: using the processing unit and the image capture device to identify the nearest detection position y_{s,a} corresponding to the measurement positions x_{r-b,a}, x_{r-b+1,a} . . . x_{r,a}, and using the pressure transducer to obtain at least one pressure P_{s,a} of the flow front of the resin corresponding to the detection position y_{s,a};

Step 7: substituting the pressure P_{s,a} obtained in Step 6 and the measurement positions x_{r-b,a}, x_{r-b+1,a} . . . x_{r,a} into Equation (2):

$$\frac{- {P}_{s , a}}{{x}_{i , a} - {y}_{s , a}} \approx ( \frac{\partial P}{\partial x} ) i , a \qquad ( 2 )$$

wherein i=r−b, r−b+1 . . . r, whereby to obtain

$$( \frac{\partial P}{\partial x} ) r - b , a , ( \frac{\partial P}{\partial x} ) r - b + 1 , a ⋯ ( \frac{\partial P}{\partial x} ) r , a$$

corresponding to the measurement positions x_{r-b,a}, x_{r-b+1,a} . . . x_{r,a}, and expressing them with the matrix of Equation (3):

$${P}_{r , a} = [ \begin{matrix}- {( \frac{\partial P}{\partial x} )}_{r - b , a} \\ - {( \frac{\partial P}{\partial x} )}_{r - b + 1 , a} \\ ⋮ \\ - {( \frac{\partial P}{\partial x} )}_{r , a}\end{matrix} ] \qquad ( 3 )$$

Next, substituting the measurement positions x_{r-b,a}, x_{r-b+1,a} , . . . x_{r,a} obtained in Step 5 and the time points of t_{r-b}, t_{r-b+1} . . . tᵣ into Equation (4):

$$\frac{{x}_{i , j} - {x}_{i - 1 , j}}{Λ T} \approx {u}_{i , j}^{°} \qquad ( 4 )$$

wherein u_{i,j}^{∘} is the Seepage velocity at the measurement position x_{i,j}, and ΔT=tᵢ−tᵢ₋₁, i=r−b, r−b+1 . . . r, whereby is obtained u_{r-b,a}^{∘}, u_{r-b+1,a}^{∘} . . . u_{r,a}^{∘} corresponding to the measurement positions x_{r-b,a}, x_{r-b+1,a} . . . x_{r,a}, and expressing them with the matrix of Equation (5):

$${U}_{r , a} = [ \begin{matrix}{u}_{r - b , a}^{°} \\ {u}_{r - b + 1 , a}^{°} \\ ⋮ \\ {u}_{r , a}^{°}\end{matrix} ] \qquad ( 5 )$$

Step 8: using the processing unit to substitute P_{r,a} of Equation (3) and U,_{r,a} of Equation (5) into Equation (6):

K_{r,a}=μØ(P_{r,a}^{T}P_{r,a})⁻¹P_{r,a}^{T}U_{r,a} (6)

to acquired the permeability K_{r,a} at the measurement position x_{r,a}, wherein Ø is the porosity of the preform and μ is the viscosity of the resin, whereby is acquired the permeability at a specified position on the plane.

Thereby, the method of the present invention can perform online measurement of the local permeability of the resin and thus can learn the states and parameters of the resin flow instantaneously. Then is understood the RTM process. In addition to being applied to monitor the flowing behaviors and the fabrication process, the online measurement results of the present invention can also be used to modify the flowing parameters and optimize the fabrication process to achieve the best quality of RTM.

### BRIEF DESCRIPTION OF THE DRAWINGS

FIG. 1 schematically shows a system layout according to one embodiment of the present invention.

FIG. 2 schematically shows an RTM apparatus according to one embodiment of the present invention.

FIG. 3 schematically shows a plane of a molding unit according a first embodiment of the present invention.

FIG. 4 schematically shows the positions of a detection module according the first embodiment of the present invention.

FIG. 5 schematically showing a top view of the detection module according the first embodiment of the present invention.

FIG. 6 schematically shows a system layout in Step 2 according the first embodiment of the present invention.

FIG. 7 schematically shows the flowing of the resin according the first embodiment of the present invention.

### DETAILED DESCRIPTION OF THE PREFERRED EMBODIMENTS

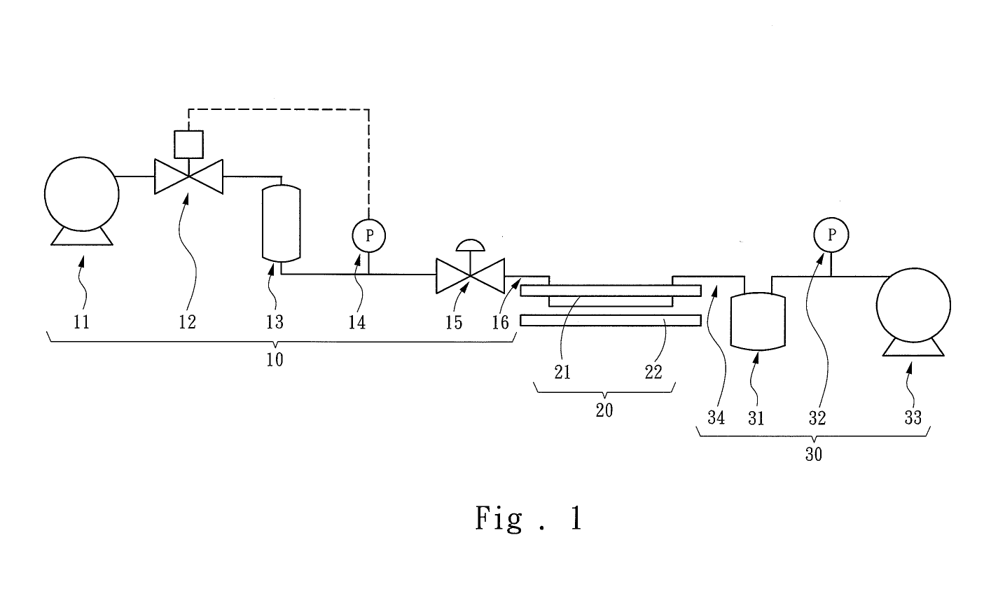

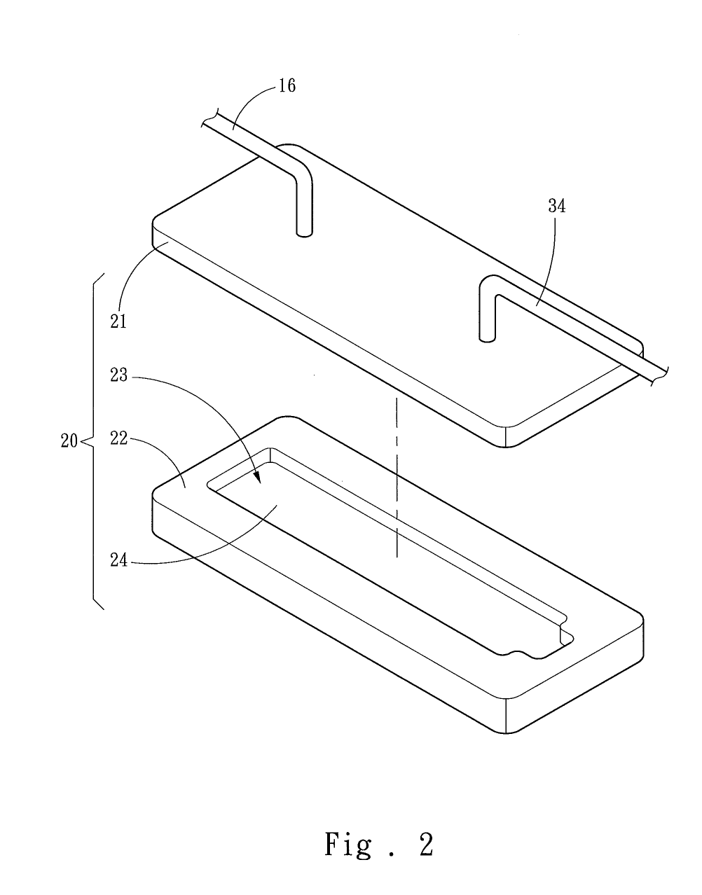

The present invention provides a method for online measurement of local permeability in resin transfer molding, which is applied to measuring permeability in a resin transfer molding (RTM) apparatus. Refer to FIG. 1 and FIG. 2 respectively schematically showing a system layout according to one embodiment of the present invention and an RTM apparatus according to one embodiment of the present invention. The RTM apparatus comprises a resin supply unit 10 and a molding unit 20 connected with the resin supply unit 10. The molding unit 20 includes an upper mold 21, a lower mold 22, a mold cavity 23 accommodating a pre-woven fiber object (a preform), and a plane 24 inside the mold cavity 23. In the first embodiment, the RTM apparatus further comprises a vacuum unit 30. The resin supply unit 10 includes an air compressing portion 11, a pressure regulator 12, a resin tank 13, a front pressure transducer 14, a pneumatic valve 15, and a resin filling piping 16. The vacuum unit 30 includes a vacuum bucket 31, a back pressure transducer 32, a vacuum pump 33, and a vacuum-pumping piping 34. A plurality of first pipes connects the air compressing portion 11, pressure regulator 12, resin tank 13, front pressure transducer 14 and pneumatic valve 15. The resin supply unit 10 is connected with the molding unit 20 through the resin filling piping 16 and thus interconnects with the mold cavity 23, whereby the resin can be filled into the mold cavity 23. A plurality of second pipes connects the vacuum bucket 31, back pressure transducer 32 and vacuum pump 33. The vacuum unit 30 is connected with the molding unit 20 through the vacuum-pumping piping 34 to extract the residual gas from the mold cavity 23.

In a first embodiment, the method of the present invention comprises Steps 1-6.

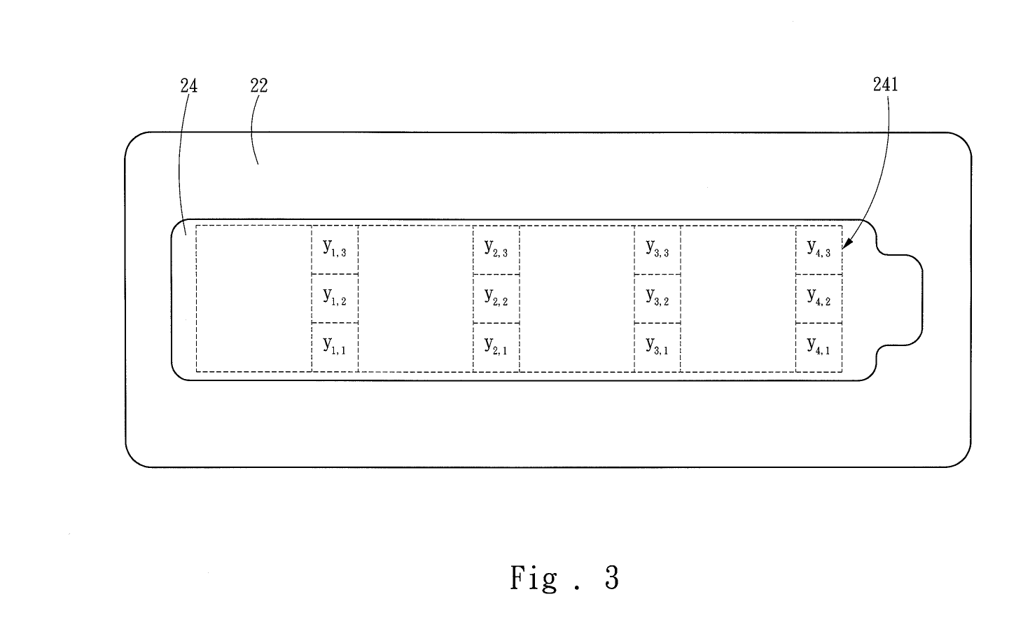

Refer to FIG. 3 schematically showing the plane 24 of the molding unit 20 according the first embodiment of the present invention. In Step 1, define on the plane 24 a plurality of detection positions y_{m,n} whose number amounts to m×n. In the first embodiment, the detection positions y_{m,n} are arranged into a matrix-like form having a plurality of longitudinal rows and a plurality of transverse columns. The number of the longitudinal rows is expressed by m, and m=1-4. The number of the transverse columns is expressed by n, and n=1-3.

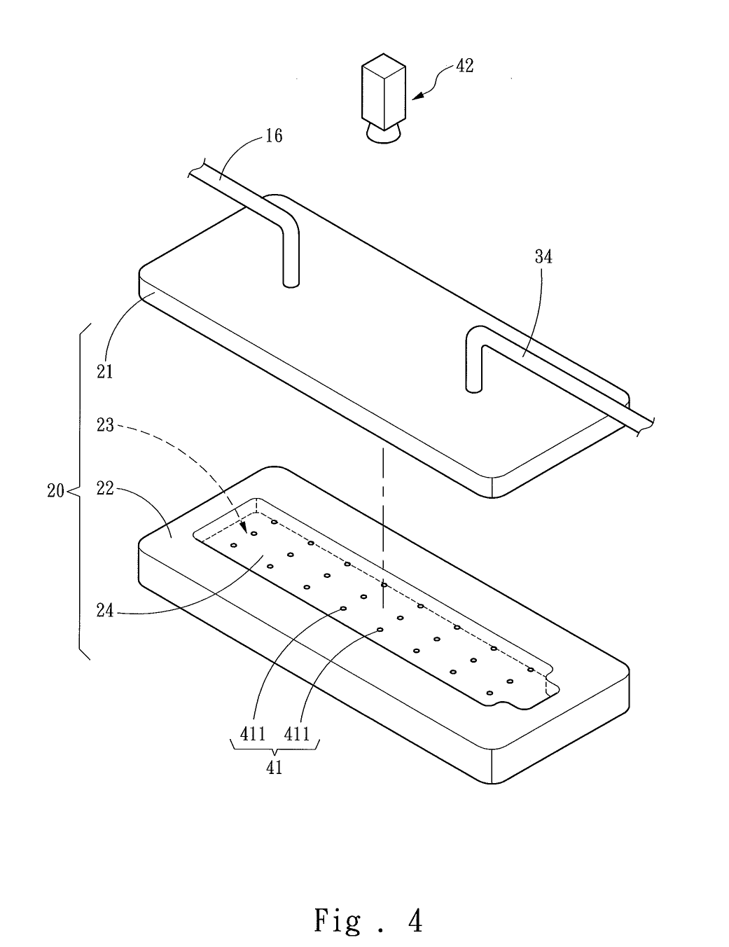

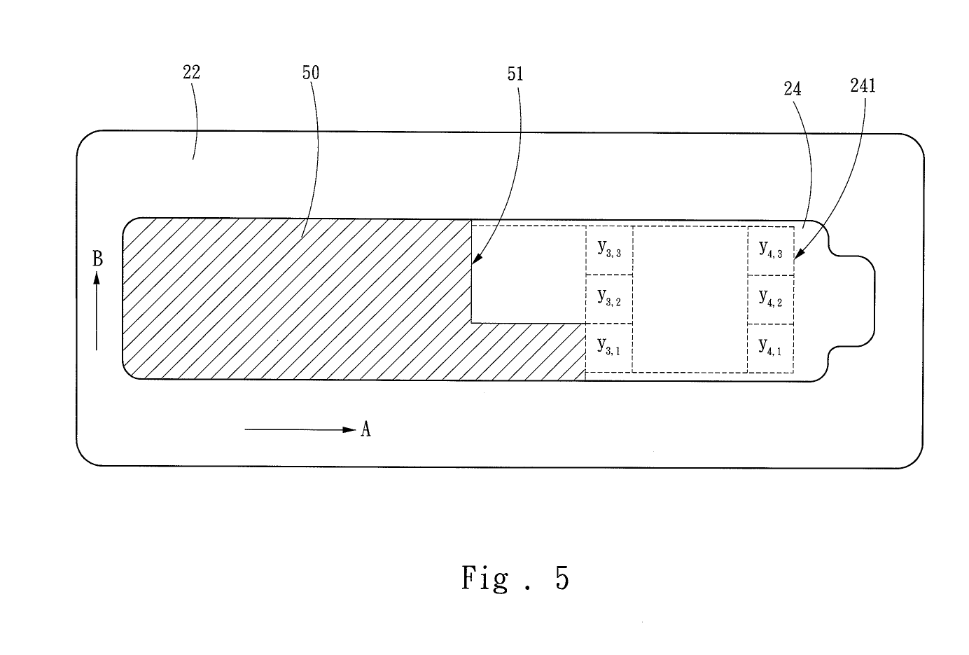

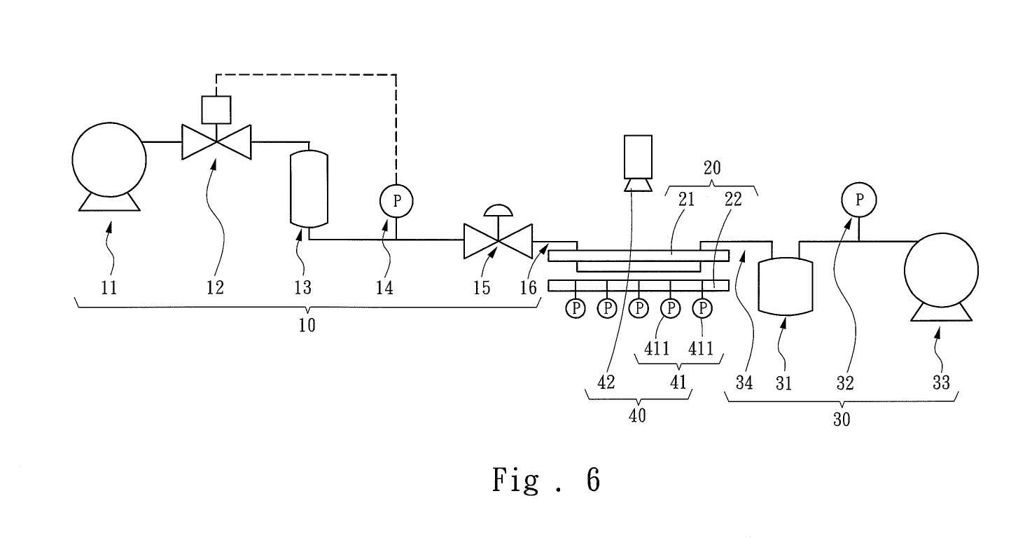

Refer to FIGS. 4-6 respectively a diagram schematically showing the positions of a detection module, a top view schematically showing a detection module, and a diagram schematically a system layout, according the first embodiment of the present invention. In Step 2, provide a detection module 40 including a pressure transducer unit 41, at least one image capture device 42 and a processing unit. The pressure transducer unit 41 is arranged in the detection positions y_{m,n}. The image capture device 42 is arranged on one side of the plane 24. The processing unit is electrically connected with the pressure transducer unit 41 and the image capture device 42. The pressure transducer unit 41 includes m×n pieces of pressure transducers 411 arranged corresponding to the detection positions y_{m,n}. In the first embodiment, there are totally 12 pieces of pressure transducers 411 also arranged into a matrix-like form having a plurality of longitudinal rows and a plurality of transverse columns.

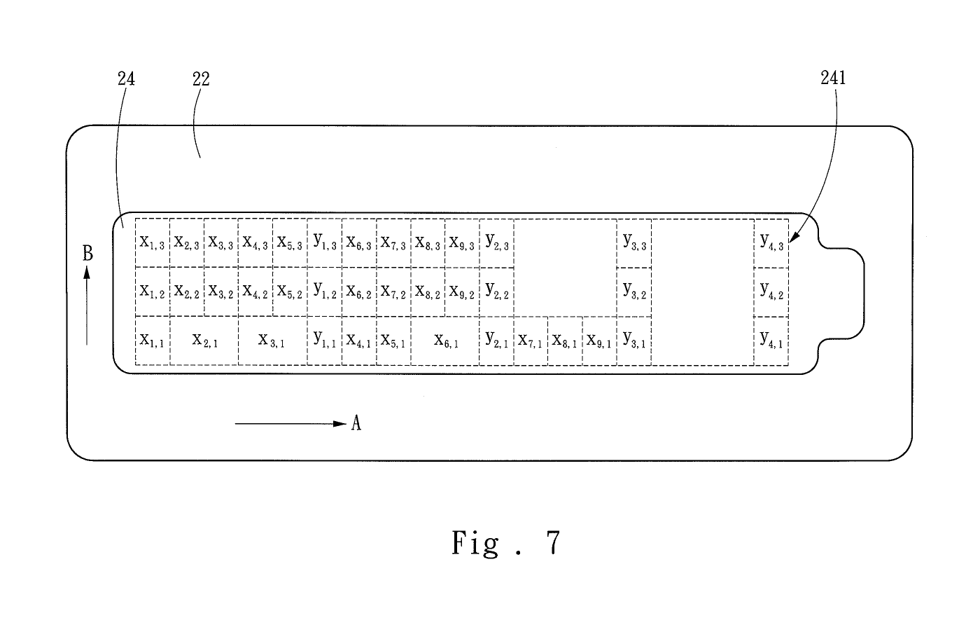

Refer to FIG. 7 schematically showing the flowing resin according the first embodiment of the present invention. In Step 3, fill a resin 50 into the mold cavity 23 and let the resin 50 flow on the plane 24 along a direction A.

In Step 4, use the image capture device 42 to record the flowing of the resin 50 to obtain the position of a flow front 51 of the resin 50 on the plane 24 at a time point tᵢ so as to define on the plane 24 a plurality of measurement positions x_{i,j}, whose number amounts to i×j, wherein the time point tᵢ and the time point tᵢ₋₁ are separated by a sampling interval, and wherein the measurement position x_{i,j} is a position corresponding to the position of the flow front 51 of the resin 50 in the jth transverse row at the time point tᵢ, and wherein i denotes the ith sampling time point, and j is an integer related to n. In the first embodiment, i=1-9, and j=n=1-3.

In Step 5, respectively set i and j to be preset values r and a, wherein r is an integer greater than 1 and a is an integer greater than or equal to 1; use the image capture device 42 to obtain the measurement positions x_{r,a} and x_{r-1,a} of the flow front 51 of the resin 50 respectively at the time points tᵣ and the time point tᵣ₋ₗ, which are separated by a sampling interval; use the pressure transducer 411 nearest to the measurement position x_{r,a} to obtain the pressure P_{s,a} of the flow front 51 of the resin 50 at the detection position y_{s,a}.

Refer to FIG. 7 schematically showing the position of the flow front 51 of the resin 50 at the time point tᵣ according the first embodiment of the present invention. Let r=9 and a=1. Thus, t₉ is the 9th sampling time point for the flowing resin 50. As shown in FIG. 7, the flow front 51 of the resin 50 has reached the pressure transducers 411 at the detection positions y_{1,1} and y_{2,1}. The detection position y_{2,1} is the detection position nearest to the measurement position x_{9,1}. Thus, let s=2. In fact, the value of s correlates with the measurement position x_{r,a}. It is learned via the image capture device 42: the flow front 51 of the resin 50 respectively reaches the measurement positions x_{9,1} and x_{8,1} at time points t₉ and t₈. As the detection position nearest to the measurement position x_{9,1} is the detection position y_{2,1}, the pressure transducer 411 at the detection position y_{2,1} is used to detect the pressure P_{2,1} of the flow front 51 of the resin 50 at the detection position y_{2,1}. In the first embodiment, it is supposed: the Seepage velocity of the flow front 51 of the resin 50 along the direction of y_{1,1}, y_{2,1} . . . y_{4,1} is greater than the Seepage velocity along the direction of y_{1,2}, y_{2,2} . . . y_{4,2} and the direction of y_{1,3}, y_{2,3} . . . y_{4,3}. Thus, the flow front 51 is distributed as that shown in FIG. 7. In practical applications, the distribution of the detection positions y_{m,n} may be different from that of the first embodiment. The distribution of the measurement positions of the flow front 51 of the resin 50 is dependent on the flowing behavior of the resin a50 and the length of the sampling interval. It should be noted: the first embodiment is only to exemplify the present invention but not to limit the scope of the present invention.

In Step 6, use the processing unit to obtain the permeability K_{r,a} of a measurement position x_{r,a} with Equation (1):

$${K}_{r , a} - \frac{μ ∅}{{P}_{s , a} Δ T} ( {x}_{r , a} - {x}_{r - 1 , a} ) ( {x}_{r , a} - {y}_{s , a} ) \qquad ( 1 )$$

wherein Ø is the porosity of the preform, μ the fluid viscosity of the resin, ΔT=tᵣ−tᵣ₋₁, whereby is acquired the permeability of the resin 50 at a specified position on the plane 24. In the first embodiment, Equation (1) is equal to Equation (7):

$${K}_{9 , 1} = \begin{matrix}μ ∅ \\ {P}_{2 , 1} Δ T\end{matrix} ( {x}_{9 , 1} {x}_{8 , 1} ) ( {x}_{9 , 1} {y}_{2 , 1} ) \\ wherein \\ Δ T = {t}_{9} - {t}_{8} . \qquad ( 7 )$$

Below is explained the deduction of Equation (1), which is dependent on the supposition: the absolute pressure of the flow front 51 of the resin 50 is zero, and the pressure gradient is approximately equal to Equation (8):

$${( \frac{\partial P}{\partial x} )}_{r , a} \approx \frac{- {P}_{r - 1 , a}}{{x}_{r , a} - {x}_{r 1 , a}} \qquad ( 8 )$$

wherein P_{r-1,a} is the pressure at the rth sampling point at the position of the flow front at the (r−1)th sampling time point and can be obtained via interpolation of the pressures measured by the transducers 411, and wherein xᵣ and xᵣ₋₁ are respectively the positions of the flow front at the rth sampling time point and the (r−1)th sampling time point. The pressure drop can be further approximated to be Equation (9):

$${( \frac{\partial P}{\partial x} )}_{r , a} \approx \frac{- {P}_{s , a}}{{x}_{r , a} - {y}_{s , a}} \qquad ( 9 )$$

wherein P_{s,a} and y_{s,a} are respectively the measurement value and position of the sth pressure transducer 411. Substitute the pressure drop estimation equation into Equation (10):

$${u}_{r , a}^{°} = \begin{matrix}{K}_{r , a} \\ ∅μ\end{matrix} {( \begin{matrix}\partial P \\ \partial x\end{matrix} )}_{r , a} \qquad ( 10 )$$

to obtain Equation (11):

$$\frac{{x}_{r , a} - {x}_{r - 1 , a}}{Λ T} \approx \frac{{K}_{r , a}}{∅μ} \cdot \frac{{P}_{s , a}}{{x}_{r , a} - {y}_{s , a}} \qquad ( 11 )$$

wherein

$$\frac{{x}_{r , a} - {x}_{r - 1 , a}}{Δ T}$$

is the approximation of u_{r,a}⁶⁰² and ΔT is the sampling interval. Then, rearrange Equation (11) to obtain Equation (1). The deduction of Equation (10) is according to the Darcy's Law.

Below is described a second embodiment of the present invention. Steps 1-4 of the second embodiment are the same as those of the first embodiment. In Step 5 of the second embodiment, i and j are respectively set to be preset values r and a, wherein r is an integer greater than or equal to 3, and a is an integer greater than or equal to 1. In Step 5, use the image capture device 42 to obtain the measurement positions x_{r-b,a}, x_{r-b+1,a} . . . x_{r,a} of the flow front 51 of the resin 50 at the time points t_{r-b}, t_{r-b+1} . . . tᵣ, wherein b is an integer greater than zero and r−b>0, and wherein each two neighboring time points of t_{r-b}, t_{r-b+1}. . . tᵣ are separated by the sampling interval. In the second embodiment, a=1, r=9, and b=5. Therefore, the image capture device 42 obtains the measurement positions x_{4,1}, x_{5,1}, x_{6,1}, x_{7,1}, x_{8,1}, x_{9,1} of the flow front 51 of the resin 50 at the time points t₄, t₅, t₆, t₇, t_{8,} t₉.

In Step 6, use the processing unit and the image capture device 43 to identify the detection positions y_{s,a} nearest to the measurement positions x_{r-b,a}, x_{r-b+1,a} . . . x_{r,a}, and use the pressure transducers 411 to obtain at least one pressure P_{s,a} of the flow front 51 of the resin 50 at the corresponding detection positions y_{s,a}. In the second embodiment, the detection position nearest to the measurement positions x_{4,1}, x_{5,1} is y_{1,1}; the detection position nearest to the measurement positions x_{6,1}, x_{7,1}, x_{8,1}, x_{9,1} is y_{2,1}. Therefore, the pressure transducers 411 at the detection positions y_{1,1}, y_{2,1} are used to detect the pressures P_{1,1}, P_{2,1} at the detection positions y_{1,1}, y_{2,1}.

In Step 7, substitute the pressure P_{s,a}, obtained in Step 6 and the measurement positions x_{r-b,a}, x_{r-b+l,a} . . . x_{r,a} obtained in Step 5 into Equation (2):

$$\frac{- {P}_{s , a}}{{x}_{i , a} - {y}_{s , a}} \approx {( \frac{\partial P}{\partial x} )}_{i , a} \qquad ( 2 )$$

wherein i=r−b, r−b+1 . . . r, whereby to obtain

$${( \begin{matrix}\partial P \\ \partial x\end{matrix} )}_{r - b , a} , {( \begin{matrix}\partial P \\ \partial x\end{matrix} )}_{r - b + 1 , a} … {( \begin{matrix}\partial P \\ \partial x\end{matrix} )}_{r , a}$$

corresponding to the measurement positions x_{r-b,a}, x_{r-b+1,a} . . . x_{r,a}, and express them with the matrix of Equation (3):

$${P}_{r , a} = [ \begin{matrix}- {( \frac{\partial P}{\partial x} )}_{r - b , a} \\ - {( \frac{\partial P}{\partial x} )}_{r - b + 1 , a} \\ ⋮ \\ - {( \frac{\partial P}{\partial x} )}_{r , a}\end{matrix} ] \qquad ( 3 )$$

Next, substitute the measurement positions x_{r-b,a}, x_{r-b+1,a} . . . x_{r,a} obtained in Step 5 and the time points of t_{r-b}, t_{r-b+1} . . . tᵣ into Equation (4):

$$\frac{{x}_{i , j} - {x}_{i - 1 , j}}{Δ T} \approx {u}_{i , j}^{°} \qquad ( 4 )$$

wherein u_{i,j}^{∘} is the Seepage velocity at the measurement position x_{i,j}, and ΔT=t₁−tᵢ₋₁, i=r−b, r−b+1 . . . r, whereby is obtained u_{r-b,a}^{∘}, u_{r-b+1,a}^{∘} . . . u_{r,a}⁶⁰² corresponding to the measurement positions x_{r-b,a}, x_{r-b+1,a} . . . x_{r,a}, and express them with the matrix of Equation (5):

$${U}_{r , a} = [ \begin{matrix}{u}_{r - b , a}^{°} \\ {u}_{r - b + 1 , a}^{°} \\ ⋮ \\ {u}_{r , a}^{°}\end{matrix} ] \qquad ( 5 )$$

Next, continue to use the conditions in Step 5: the pressure P_{1,1} corresponding to the measurement position x_{4,1}, the pressure P_{1,1} corresponding to the measurement position x_{5,1}, the pressure P_{2,1} corresponding to the measurement position x_{6,1}, the pressure P_{2,1} corresponding to the measurement position x_{7,1}, the pressure P_{2,1} corresponding to the measurement position x_{8,1}, and the pressure P_{2,1} corresponding to the measurement position x_{9,1}, and substitute the abovementioned conditions into Equation (2) to obtain

$${( \frac{\partial P}{\partial x} )}_{4.1} , {( \frac{\partial P}{\partial x} )}_{5.1} , {( \frac{\partial P}{\partial x} )}_{6.1} , {( \frac{\partial P}{\partial x} )}_{7.1} , {( \frac{\partial P}{\partial x} )}_{8.1} , {( \frac{\partial P}{\partial x} )}_{9.1}$$

respectively corresponding to the measurement positions x_{4,1}, x_{5,1}, x_{6,1}, x_{7,1}, x_{8,1}, x_{9,1}, and express them with the matrix in the following equation:

$${P}_{9.1} = [ \begin{matrix}- {( \frac{\partial P}{\partial x} )}_{4.1} \\ - {( \frac{\partial P}{\partial x} )}_{5.1} \\ - {( \frac{\partial P}{\partial x} )}_{6.1} \\ - {( \frac{\partial P}{\partial x} )}_{7.1} \\ - {( \frac{\partial P}{\partial x} )}_{8.1} \\ - {( \frac{\partial P}{\partial x} )}_{9.1}\end{matrix} ]$$

Next, substitute the measurement positions x_{4,1}, x_{5,1}, x_{6,1}, x_{7,1}, x_{8,1}, x_{9,1} obtained in Step 5 and the time points t₄, t₅, t₆, t₇ , t₈, t₉ into Equation (4) to obtain

$${( \frac{\partial P}{\partial x} )}_{4.1} , {( \frac{\partial P}{\partial x} )}_{5.1} , {( \frac{\partial P}{\partial x} )}_{6.1} , {( \frac{\partial P}{\partial x} )}_{7.1} , {( \frac{\partial P}{\partial x} )}_{8.1} , {( \frac{\partial P}{\partial x} )}_{9.1}$$

corresponding to the measurement positions x_{4,1}, x_{5,1}, x_{6,1}, x_{7,1}, x_{8,1}, x_{9,1}, and express them with the matrix in the following equation:

$${U}_{r , a} = [ \begin{matrix}{u}_{4.1}^{°} \\ {u}_{5.1}^{°} \\ {u}_{6.1}^{°} \\ {u}_{7.1}^{°} \\ {u}_{8.1}^{°} \\ {u}_{9.1}^{°}\end{matrix} ]$$

In Step 8, use the processing unit to substitute P_{r,a} of Equation (3) and U_{r,a} of Equation (5) into Equation (6):

K_{r,a}=μØ(P_{r,a}^{T}P_{r,a})⁻¹P_{r,a}^{T}U_{r,a} (6)

to acquire the permeability K_{r,a} at the measurement position x_{r,a}, wherein Ø is the porosity of the preform and μ is the viscosity of the resin. Thereby is acquired the permeability of the resin 50 at a specified position on the plane 24.

Then, substitute the conditions in Step 4 into Equation (6) and acquire the permeability K_{9,1}:

K_{9,1}=μØ(P_{9,1}^{T}P_{9,1})⁻¹P_{9,1}^{T}U_{9,1}

Below is further explained the second embodiment. The Darcy's Law is simplified to have a matrix form and obtain Equation (12):

$${U}_{r , a} = \frac{{K}_{r , a}}{μφ} {P}_{r , a} \qquad ( 12 )$$

In the abovementioned embodiments, we take a plurality of samples around the measurement positions where the permeability is to be measured, and use the size of the window and the stride of movements to express the number of samples and the spacing between the samples (or the sampling interval). In the abovementioned embodiments, b+1 in Step 5 expresses the number of samples. In the abovementioned embodiments, we use the least square method in estimation and introduce the residual ε and the loss function L to obtain Equations (13) and (14):

$$\begin{matrix}{ɛ}_{i} = {u}_{i , a}^{°} - \frac{{K}_{r , a}}{μ φ} ( - {( \frac{\partial P}{\partial x} )}_{i , a} ) & ( 13 ) \\ L = \frac{1}{b + 1} {\sum }_{i = r - b}^{r} {ɛ}_{i}^{2} & ( 14 )\end{matrix}$$

Next, select K_{r,a} to minimize the loss function, i.e. work out the extremum of the 2-norm of c, to obtain Equation (15):

$${min}_{{K}_{r , a}} {‖ {U}_{r , a} - \frac{{K}_{r , a}}{μφ} {P}_{r , a} ‖}^{2} \qquad ( 15 )$$

Then, calculate the first derivative of L(K_{r,a}) with respect to K_{r,a} and let the first derivative equal to zero to obtain Equation (16):

$$\frac{\partial L ( {K}_{r , a} )}{\partial {K}_{r , a}} = 0 \qquad ( 16 )$$

Thus is acquired Equation (6):

$$\frac{\partial L ( {K}_{r , a} )}{\partial {K}_{r , a}} = 0 \qquad ( 6 )$$

In conclusion, the present invention proposes a method for online measurement of local permeability in resin transfer molding, which can perform an online measurement of the local permeability of the resin and thus can learn the states and parameters of the resin flow instantaneously. Then is understood the RTM process. In addition to being applied to monitoring the flowing behaviors and the fabrication process on line, the online measurement results of the present invention can also be used to control the air compressing portion and the pressure regulator so as to modify the flowing parameters, optimize the fabrication process and improve the quality of RTM products.

What is claimed is:

1. A method for online measurement of local permeability in resin transfer molding, which is applied to measuring a permeability in a resin transfer molding apparatus, wherein the resin transfer molding apparatus comprises a resin supply unit and a molding unit connected with the resin supply unit, and wherein the molding unit includes a mold cavity accommodating a pre-woven fiber object and a plane inside the mold cavity, and wherein the method comprises:
Step 1: defining on the plane a plurality of detection positions y_{m,n} whose number amounts to m×n;
Step 2: providing a detection module including a pressure transducer unit arranged in the detection positions y_{m,n}, at least one image capture device arranged on one side of the plane and a processing unit electrically connected with the pressure transducer unit and the image capture device, wherein the pressure transducer unit includes m×n pieces of pressure transducers;
Step 3: filling a resin into the mold cavity and letting the resin flow on the plane along a direction;
Step 4: using the image capture device to obtain positions of a flow front of the resin on the plane at a time point tᵢ, so as to define on the plane a plurality of measurement positions x_{i,j}, whose number amounts to i×j, wherein the time point tᵢ, and the time point tᵢ₋₁ are separated by a sampling interval, and wherein the measurement position x_{i,j} is a position corresponding to the position of the flow front of the resin at the time point tᵢ, and wherein i denotes the ith sampling time point, and j is an integer related to n;
Step 5: setting i and j to be preset values r and a respectively, wherein r is an integer greater than 1 and a is an integer greater than or equal to 1; using the image capture device to obtain the measurement positions x_{r,a} and x_{r-1,a} of the flow front of the resin respectively at the time points tᵣ and the time point tᵣ₋₁; using the pressure transducer nearest to the measurement position x_{r,a} and the resin has reached to obtain the pressure P _{s,a} of the resin at the detection position y_{s,a}; and
Step 6: using the processing unit to obtain a permeability K_{r,a} of the measurement position x_{r,a} with Equation (1):
$${K}_{r , a} = \frac{μφ}{{P}_{s , a} Δ T} ( {x}_{r , a} - {x}_{r - 1 , a} ) ( {x}_{r , a} - {y}_{s , a} ) \qquad ( 1 )$$
wherein Ø is a porosity of the pre-woven fiber object, μ a fluid viscosity of the resin, ΔT=tᵣ−tᵣ₋₁, whereby is acquired the permeability of the resin at a specified position on the plane.

2. A method for online measurement of local permeability in resin transfer molding, which is applied to measuring a permeability in a resin transfer molding apparatus, wherein the resin transfer molding apparatus comprises a resin supply unit and a molding unit connected with the resin supply unit, and wherein the molding unit includes a mold cavity accommodating a pre-woven fiber object and a plane arranged inside the mold cavity and allowing a resin to flow thereon, and wherein the method comprises
Step 1: defining on the plane a plurality of detection positions y_{m,n} whose number amounts to m×n;
Step 2: providing a detection module including a pressure transducer unit arranged in the detection positions y_{m,n}, at least one image capture device arranged on one side of the plane and a processing unit electrically connected with the pressure transducer unit and the image capture device, wherein the pressure transducer unit includes m×n pieces of pressure transducers;
Step 3: filling the resin into the mold cavity and letting the resin flow on the plane along a direction;
Step 4: using the image capture device to obtain positions of a flow front of the resin on the plane at a time point tᵢ so as to define on the plane a plurality of measurement positions x_{i,j}, whose number amounts to i×j, wherein the time point tᵢ and the time point tᵢ₋₁ are separated by a sampling interval, and wherein the measurement position x_{i,j} is a position corresponding to the position of the flow front of the resin at the time point tᵢ, and wherein i denotes the ith sampling time point, and j is an integer related to n;
Step 5: setting i and j to be preset values r and a respectively, wherein r is an integer greater than or equal to 3, and a is an integer greater than or equal to 1; using the image capture device to obtain the measurement positions x_{r-b,a}, x_{r-b+1,a} . . . x_{r,a} of the flow front of the resin at the time points t_{r-b}, t_{r-b+1} . . . tᵣ, wherein b is an integer greater than zero and r−b>0, and wherein each two neighboring time points of t_{r-b}, t_{r-b+1} . . . tᵣ are separated by the sampling interval;
Step 6: using the processing unit and the image capture device to identify the detection positions y_{s,a} nearest to the measurement positions x_{r-b,a}, x_{r-b+1,a} . . . x_{r,a}, and using the pressure transducers to obtain at least one pressure P_{s,a} of the flow front of the resin at the corresponding detection positions y_{s,a};
Step 7: substituting the pressure P, obtained in Step 6 and the measurement positions x_{r-b,a}, x_{r-b+1,a} . . . x_{r,a} into Equation (2):
$$\frac{- {p}_{s , a}}{{x}_{i , a} - {y}_{s , a}} \approx {( \frac{\partial P}{\partial x} )}_{i , a} \qquad ( 2 )$$
wherein i=r−b, r−b+1 . . . r, whereby to obtain
$${( \frac{\partial P}{\partial x} )}_{r - b , a ,} {( \frac{\partial P}{\partial x} )}_{r - b + 1 , a} … {( \frac{\partial P}{\partial x} )}_{r , a}$$
corresponding to the measurement positions x_{r-b,a}, x_{r-b+1,a} . . . x_{r,a}, and expressing them with a matrix of Equation (3):
$${P}_{r , a} = [ \begin{matrix}- {( \frac{\partial P}{\partial x} )}_{r - b , a} \\ - {( \frac{\partial P}{\partial x} )}_{r - b + 1 , a} \\ ⋮ \\ - {( \frac{\partial P}{\partial x} )}_{r , a}\end{matrix} ] ; \qquad ( 3 )$$
next, substituting the measurement positions x_{r-b,a}, x_{r-b+1,a} . . . x_{r,a} obtained in Step 5 and the time points of t_{r-b}, t_{r-b+1} . . . tᵣ into Equation (4):
$$\frac{{x}_{i , j} - {x}_{i - 1 , j}}{Δ T} \approx {u}_{i , j}^{°} \qquad ( 4 )$$
wherein u_{i,j}⁶⁰² is a Seepage velocity at the measurement position x_{i,j}, and ΔT=tᵢ−tᵢ₋₁, i=r−b, r−b+1 . . . r, whereby is obtained u_{r-b,a}^{∘},u_{r-b+1,a}^{∘} . . . u_{r,a}^{∘} corresponding to the measurement positions x_{r-b,a}, x_{r-b+1,a} . . . x_{r,a}, and expressing them with a matrix of Equation (5):
$${U}_{r , a} = [ \begin{matrix}{u}_{r - b , a}^{°} \\ {u}_{r - b + 1 , a}^{°} \\ ⋮ \\ {u}_{r , a}^{°}\end{matrix} ] \qquad ( 5 )$$
Step 8: using the processing unit to substitute P_{r-b,a} of Equation (3) and U_{r-b,a} of Equation (5) into Equation (6):
K_{r,a}=μØ(P_{r,a}^{T}P_{r,a})¹P_{r,a}^{T}U_{r,a} (6)
wherein Ø is a porosity of the pre-woven fiber object, μ a fluid viscosity of the resin (50), ΔT=tᵣ−tᵣ₋₁, whereby is acquired the permeability of the resin (50) at a specified position on the plane (24).
